(19) United States
(12) Patent Application Publication
(10) Pub. No.: US 2005/0143919 A1
(43) Pub. Date: Jun. 30, 2005

(54) Unified method and system for multi-dimensional mapping of spatial-energy relationships among micro and macro-events in the universe

(76) Inventor: Robert Edward Williams, LLano, CA (US)

Correspondence Address: ROBERT EDWARD WILLIAMS, P.O. BOX 152, LLANO, CA, 93544, US

(21) Appl. No.: 10/714,142

(22) Filed: Nov. 14, 2003

(51) Int. Cl. G06F 19/00

(52) U.S. Cl. 702/1

(57) ABSTRACT

A unified method and system that utilizes non-geodesic Platen (26) geometry of integrated Small Circles (52) and Small Polygons (54) to generate maps of spatial-energy relationships among micro-Events and macro-Events in the Universe. This method and system assumes universal continuous integrated relationships among all Events (22) with Spatial structures. This iterative method and system of map-making can be directional (30) and/or omni-directional (62) in its pattern of development. Maps generated with this method and system can show hierarchical levels of existence and multi-dimensional relationships among Events in the Universe. The mapping method and system shows energetic components inherent in the structural fabric of Space (66) and demonstrates the explanation for the expansion of the Universe.

### CROSS-REFERENCE TO RELATED APPLICATIONS

Not applicable

### FEDERALLY SPONSORED RESEARCH

Not applicable

### SEQUENCE LISTING OR PROGRAM

Not applicable

A portion of the disclosure of this patent document contains material that is subject to copyright protection. The copyright owner has no objection to the facsimile reproduction by anyone of the patent disclosure as it appears in the Patent and Trademark Office patent files or records, but reserves all copyright rights whatsoever.

### BACKGROUND

1. Field of Invention

This invention relates to methods and systems for determining fundamental relationships among discrete Events with maps and models. More specifically, this invention presents a unified method and system, using the geometry and topology of interconnected Platens, for mapping the spatial relationships and the energy relationships among Events in the Universe. The maps developed by the method and system of this invention range from sub-microscopic fundamental particles, to large bodies or clusters of bodies on the astronomical scale, to social-psychological-political-economic-relationships that interact on varying hierarchical levels and dimensionalities.

2. Description of Prior Art

### Brief Glossary

In order to facilitate a clear understanding of the nature and intent of the present invention the following terms, definitions, distinctions, and assumptions are specified and designated by the inventor, and in constant use in this patent. It is noted that, though the present invention makes use of concepts usually associated with mathematics and the physical sciences, the concepts also apply to other disciplines such as: anthropology, archaeology, architecture, ecology, economics, forestry, geography, geology, linguistics, marketing, operations research, physiology, political science, psychology, regional planning, remote sensing, sociology, statistics, and urban planning.

Event: Event 22 represents the generalized class of masses, beings, entities, interactions, fields, and energies.

Platen: A Platen 26 is the interfacing boundary between a minimum of two Events 22. A Platen is the area between and congruent with the Domain Boundaries 34 that connect and/or separate every two Events in relationship. (See FIG. 3)

Domain: A Domain 32 is the area, volume, or hyper-volume belonging to a specific Event. A Domain encloses or encapsulates an Event.

Domain Boundary: A Domain Boundary 34 is the spatial-energetic enclosure of n-dimensional forms enclosing a Domain in n+1 dimensions. A Domain Boundary bounds or encloses a unitary Domain of an Event. A Domain Boundary is composed of Platens, Rims, and Nodes.

Node: A Node 36 is a component of a Platen and a Domain Boundary. A Node is a confined or restricted area of Space, approaching the traditional geometric concept of point.

Rim: A Rim 38 is a perimeter boundary of a Platen and its corresponding Domain Boundary. A Rim approaches the traditional geometric concept of line.

Small Circle: A Small Circle 52 is a circle inscribed on the surface of a sphere. The center of a Small Circle does not pass through the center of the sphere.

Great Circle A Great Circle 64 is a special class of circles on a sphere in which the center of the circle passes through the center of the sphere.

Space: Space 66 is a form of energy emerging as dimension. Space and mass are considered to be two complimentary aspects of one system. On the macro-scale, Space is continuously emerging out of Platens 26 from an unknown meta-dimensional source. The emergence of the energy of new pristine Space through the gateway of Platens is the primary cause of expansion of the Universe.

Geodesic: A ‘geodesic’ is considered to be the shortest distance between to ‘points’ on any surface in any space.

Infusion: Infusion is the process by which pristine Space is integrated into cognate Space. Domain Boundaries and Platens act as gateways in the initial stages.

### OVERVIEW—PRIOR ART

In a broad sense, the history of mapmaking emerges from the beginning of the human sojourn on earth. The concepts involved are so fundamentally engrained that they form the unconscious background for most of human activity, from work to play, from strategizing to planning movement. What began with the simple need to direct movement or describe a location of some Event or place, evolved through time into distinct disciplines concerned with specialized needs and interests.

In the beginning, marks were made on a flat surface, like the ground below one's feet. Over time the markings became increasingly sophisticated in which elevations, distances, relative sizes, and the like were given formal notations imparting important information about the Events described. Thus the human intellect evolved the disciplines of geometry and mathematics, crystallography, biology, chemistry, astronomy, cartography, and the like. Each discipline developed distinctive abstract notations to map and model the world of our senses.

In order to perceive descriptions beyond those of physical Events, maps for relationships that exist within what are termed ‘hidden dimensions’ have been developed as well. Aspects of hidden dimensions exist in many disciplines of the soft sciences. Relationships among Events within the hidden dimension are more felt than seen. They manifest from an evenly spaced row of birds on a wire to the comfort distances maintained among living beings in social settings.

Socio-psychological hidden dimensions have inherent systems of maps that are intuited and invisible. They are operative in the context of social interaction, politics, economics, and the like (Hall, E. T., The Hidden Dimension. 1966, pp. 108-122.)

In many disciplines, the relationship among Events has been perceived to be static. This made mapmaking relatively easy. In other disciplines, dynamic interchange among Events presented mapping conditions difficult to describe with static concepts.

Cartography

In cartography, for example, historic maps present a record of the development of this art as it transformed into a science. The important milestones in the history of cartography emerged from a need for refinement of measurement combined with a perceived need to control the environment. Where once the shapes of land masses and locations of entities like villages, routes, mountains, valleys, lakes, rivers were often visually distorted and dissolved into the edges of a page, cartography through time developed crisp, clear, and accurate methodologies for the delineation of boundaries and measurements.

The development of trigonometry and surveying played a pivotal role for mapping the surface of a spherical earth. However, projecting the actual contour of the earth's approximately spherical form onto a flat surface has presented a persistent dilemma. Throughout the centuries, proposed solutions have had varying degrees of success.

Gerhardus Mercator (1512-1594) was pre-eminent in developing early methods of projecting the spherical earth on a flat surface. His work was emulated and developed by others. All of the projections show huge relational distortions of land and ocean masses. U.S. Pat. No. 2,393,676 to Fuller (1946) teaches a projection of the earth's surface on a cuboctahedron (later an icosahedron) based upon great circle arcs on a sphere. This mapping technique shows minimal distortion of land and ocean masses. Fuller's teaching is probably the most significant single contribution to cartography since Mercator. His work has been followed by numerous further teachings based on great circle geometries, including U.S. Pat. No. 5,222,896 to Smith, Jr, (1993).

The impossible attempts to survey the spherical earth with equal size squares of traditional cartography or equal size triangles based on Fuller's teaching have both been shown to be unsatisfactory. In order to maintain vertex angles of 90° and 60°, respectively, the edges of the squares and triangles are segments of great circle arcs on a sphere. As a result, both systems require constant tucking and distortion of angles and edges.

A discrete global grid system for an isolated sphere such as the earth was developed in 2000. In the teaching of Song, et al., National Center for Geographic Information and Analysis, (2000), the use of the more flexible small circle geometry rather than great circle geometry to map the earth's surface resolves some of the problems created by the restrictive nature of great circle arcs.

Though these developments are interesting in themselves, the use of small circle geometry has been restricted to specific needs in the context of a single isolated entity, such as a sphere. The present mapping method and system applies to more universal considerations in the context of multiple dimensional Events.

Biology, Chemistry, Crystallography and the Structure of Liquids

These sciences have a rich history of mapping and modeling the relationships among atoms, cells, organs and the like. Geometry and topology are their common bases. The invention of the microscope opened the doors of perception. Early investigations by John Dalton (1766-1844) of atomic structure modeled after various packings and clusterings of circles and spheres led to the development of the Periodic Table of Dmitri Mendeleev and Julius Lothar Meyer in 1869, and later to the development of the Table of Nuclides in the mid 20^{th} century.

Even before the time of Dalton, astronomer Johannes Kepler (1571-1630) and others, had a clear interest in packings of spheres as models of positions of atoms in crystals, biological cell aggregations, soap froth, liquid structure, and the like.

Lawrence Bragg (1891-1971) was instrumental in developing the 230 space groups in crystallography from concepts of sphere-packing combined with assumptions of atomic structure based upon x-ray diffraction patterns in crystals. This work with atomic structure was accomplished without actually viewing atoms themselves. Stick and node models depicting the bonding and angular relationships of atoms in crystals are predominantly in use today (see Gordon, J. Chem. Educ. (1970).

Early mapping and modeling work in biology was more directly observable than the work in crystallography because cells could actually be viewed through a microscope. Many experiments were conducted with packings of soap bubbles, compressed lead shot, peas, and cells themselves. Faces, edges, and vertices of individual units were counted and analyzed. These studies were combined with studies of aggregations of spheres to develop an understanding of the geometric relationships involved. (See: Thompson, W. (Lord Kelvin), London, Edinburgh and Dublin Phil. Mag. and Jour Sci. v. 24, pp. 503-514 (1887); Thompson, D. W. On Growth and Form. New York: The Macmillan Co. 1944, pp. 356-7, 516-7, 550-7;
In all of this prior art, the precise understanding of the nature of Platens 26 and Domain Boundaries 34 that at once both separate and join Events 22, has been largely overlooked in most disciplines. Rather the focus has been directed toward developing an understanding of direct-angular-directional relationships between and among isolated Events.

In the physical sciences, studies of sound transmission, friction, and the like have addressed these concerns only generally. For various reasons, such studies have developed fairly vague theoretical constructs emphasizing isolation and separateness. This can be seen in the way that these disciplines have used models to describe spatial-energy relationships.

Important work in the second half of the 20^{th} century in both microbiology and nano-technology have resulted in the precise determination of behavior and locations of individual atoms forming complex systems with a precision in analysis. This level of precision analysis can be available to physics and astrophysics of the future by using methods of the present mapping method and system.

Mapping the Universe

Scientific developments of the last century have shown very clearly that every Event in the Universe is, in fact, dynamic, moving and pulsating, from the very small fundamental particles to the large celestial Events in deep Space. As such, they require innovative concepts for visual description of fundamental spatial and energetic relationships.

The advent of space-travel clearly requires mapmaking in a minimum of 3-dimensions, in which every Event exists in dynamic relationships with other Events within its locality. Certain astronomical Events interact for a short duration. Others form an enduring pulsating interaction. Still others are in constant motion away from one another while maintaining relatively consistent angular relationships. With these dynamic relationships among Events, the actual structure of Space is also changing dynamically.

Relationships such as the above can be considered to be roughly analogous to the changing spatial relationships of atoms in a slow moving liquid or the movement exhibited in a growing aggregation of random volume soap bubbles. Relationships among Events and Space that are mapped in one moment, change in the next moment.

Classic map-making and cartographic techniques in astronomy are focused primarily on visible entities to the exclusion of Space. The teaching in U.S. Pat. No. 4,970,793 to Atamian (1990) is a clear indicator of this continuing trend. Though the focus on only observable events at a distance remains of general interest, it may no longer suffice, given evolving needs coupled with advances in the mathematical, computational, and physical sciences.

With the advent of the possibility of extensive Space exploration and travel, it is apparent that a unified method and system of mapping multi-dimensional and hierarchical interactions of Events and Space in the Universe is a necessity. A method and system of mapping the fundamental unity of Space and Events is a primary goal of the present mapping method and system, by which Space-Event is presented as one continuum.

The concept that a relationship between two Events has a single cause resulting in a simple direct line, at one time termed a straight or geodesic path, continues to dominate thinking. As a result, stick and node models of relationships continue to be the norm. Even with the advent of space exploration, realization that the most efficient paths to a destination are indirect non-geodesic small circle paths has been slow in forming.

The present mapping method and system sets aside assumptions about geodesic-shortest distance paths between Events in the Universe. Rather, it is assumed that the ability to move most efficiently among Events is demonstrated to be an indirect, non-geodesic path. (See Pogosian, L., et al., Jour-ref: Phys. Lett. B423, pp. 45-8. (1997), for background). With my mapping method and system, it is possible to map multiple overlapping forces that determine fundamental small circle relationships among Events and Spaces.

For example, in the relatively small scale space-travel that man has thus far been engaged, there has been some initial work on most efficient movement for travel in space. The use of Lagrange points between the Earth, the Sun, and the Moon have served as guideposts for an innovative teaching regarding space travel. U.S. Pat. No. 6,385,512 to Belbruno (2002) teaches a method of indirectly moving an object from one body to another. Koon, W. S., et. al., Celestial Mechanics and Dynamical Astronomy, pp. 63-73, (2001), teaches a visualization of a tunnel highway for efficient movement in space-travel. These teachings represent the first uses of an optimum minimal energy travel corridor. However, the teachings are specific to ballistic trajectories and do not approach the universal scope of the present mapping method and system.

While great strides have been made in cosmology in the recent past, the proliferation of cosmology theories serves to underscore the need for a comprehensive method and system to theoretically map the entire body of the Universe. My mapping method and system demonstrates: (1) the fundamental unity of Space and Events as a continuum; and (2) the geometry and topology of hierarchical relationships among energetic configurations of Domain Boundaries, Domains, and Events.

Social and Soft Sciences:

With the present mapping method and system, maps of interactions, boundaries, perceptions, perspectives, etc. for the social and soft sciences differ in qualitative aspects from the characteristics observed in the hard sciences. However, similar visual components of my method can be of great help in all cases. As such, hierarchical levels of both hard and soft sciences can be seen to interact with one another in ways that can lead to new interdisciplinary concepts.

Theory of the Invention

### Annotated Glossary

Event: The term Event 22 refers to the generalized class of things, masses, beings, entities, interactions, fields and energies. The term Event is presented in the sense that reflects the concept of unitary activity, or verb, rather than a ‘solidity’, or noun.

An Event may be considered as unitary, though it may consist of a localized clustering of a plurality of the above, either of one kind or in combination with other kinds. An Event may also be an entire class of the above within a specific hierarchical level, embedded by (or embedding) Events at other levels. The plurality of contents comprising an Event may be regarded to exist on a different hierarchical level from the Event itself and the plurality of contents may be mapped and integrated into the hierarchy. (See FIGS. 11A and 11B.)

Two Events are considered to be in interaction when the energy or interaction between the two is greater than the energy or interaction between either of the two Events and any other Event in the vicinity of the two Events.

Platen: A Platen 26 is the interfacing boundary between a minimum of two Events 22. (See FIG. 3) A Platen can appear as a ‘small circle/polygon’ with n-Nodes and n-Rim segments that connect and/or separate two Events in relationship. A Platen may be visualized as the intervening ‘plate’ between two interfacing Domain Boundaries 34 of two Events. (See FIG. 8 and FIG. 9A).

A plurality of Platens 26 link together to establish: (1) a minimum energy relationship between two distinct Events 22; (2) a Domain Boundary 34 enclosing a Domain 32; (3) interlinked boundaries among related discrete Events. (See FIG. 1)

The Platen forms the fundamental area of Space (or boundary among Spaces) along which friction, sound, Van der Wall forces, a portion of Gravity, and the like, can move. A Platen may also be a field of energy or an energy sink forming an interface between a minimum of two Events.

Generally, Platens are closely associated to a plane perpendicular to a line connecting the center of two events in relationship. A Platen tends to be Euclidean, but may be flat, singly-curved, or doubly-curved (see FIG. 6 and FIG. 10). A Platen may or may not necessarily retain the geometric idea of flatness or thickness. The energetic configuration of a Platen is the result of all of the Spatial and Event forces acting upon it.

On a macro-scale, Platens act as gateways through which pristine Space emerges and infuses into cognate Space.

Domain: A Domain 32 is the area, volume, or hyper-volume belonging to a specific Event 22. A Domain encloses or encapsulates an Event. A Domain extends indefinitely until it is bounded by interactions with another Domain or a plurality of Domains (see FIG. 3 and FIG. 10).

Domain Boundary: A Domain Boundary 34 is the energetic outer limit of a Domain. A Domain Boundary is the spatial-energetic enclosure of n-dimensional forms enclosing a Domain in n+1 dimensions. A Domain Boundary bounds or encloses a unitary Domain of an Event. A Domain Boundary is composed of Platens, Rims, and Nodes.

In mathematics, Dirichlet Regions, Voronoi Polytopes, and Delenay Complexes, where purely geometric consid-erations are determinants of boundaries, are limited cases of the general concept of Domain Boundary. (See U.S. Pat. No. 6,433,754 to Boeringer (2002), and Satake, M., 15^{th} ASCE Engineering Mechanics Conference, pp. 1-8, (2002) for a descriptions of these limitations.) Both of these teachings are concerned with specific uses and analyses of very limited scope unrelated to the present mapping method and system.

The dimensional, physical, and mathematical concepts of the hard sciences have their counterparts in the socio-psychological-economic disciplines as well. For example: in the physical sciences, Domain relationships may initially be considered as spatial Domains from which energy Domains can be integrated into the mapping system of the present mapping method and system. In areas of the softer sciences the concepts behind the terms energy, Domains, and the like can assume much different nuances of meaning and understanding.

In the context of soft sciences, the relative sizes of interacting Domains can be determined by giving certain values to concepts such as intentionality, dominance, inclusiveness, exclusiveness, and the like. These concepts can be visually mapped in a manner similar to that used for mapping physical relationships. By using the present mapping method and system, both hard and soft sciences can develop clearer understanding of varied disciplines. They may simultaneously develop in knowledge, understanding, and commonality of approach.

Node: A Node 36 is a confined or restricted area of Space, approaching the traditional geometric concept of point. A Node is a gathering place for direction changes of grouped Rims, groups of Rim pairs, and the like, in the sense of being bundled (see FIG. 8). The concept of Node may also include: a highly constricted area of Space, a focal center for Platens of differentiated Events.

Rim: A Rim 38 is a perimeter boundary of a Platen or a group of Platens. When Platens interlink, Rims can either pass by one another or deform into a common, roughly congruent, bundle (See FIG. 7 and FIG. 8). In Euclidean geometry the concept of Rim is reduced to edge or line: a boundary or a portion of a boundary that separates or encloses.

A Rim segment is a portion of a Rim. A number of Rim segments comprise a Rim.

Small Circle and Great Circle: The concept of Platen includes what is classically termed a Small Circle 52. A Small Circle is any circle inscribed on the surface of a sphere having a radius less than the radius of the sphere. When the radius of a Small Circle is equal to the radius of the sphere, the Small Circle has transformed into a Great Circle 64.

While an infinite number of sizes of Small Circles can be inscribed on the surface of a sphere, only one species of circle is considered to be a Great Circle. The center of a Small Circle does not pass through the center of a sphere, whereas the center of a Great Circle coincides with the center of a sphere. Thus a Great Circle is a specific subset of the kinds of circles that can be inscribed on the surface of a sphere.

A Great Circle segment on a sphere is rigid in the sense that only one may be inscribed through any two points, whereas a plurality of Small Circle segments can pass through the same two points. Axes perpendicular to Small Circles and Great Circles pass through center of the sphere.

For the purposes of the present invention, the idea of circle is synonymous with the concept of polygon. Thus, a small circle is equivalent to a small polygon.

Space: Space 66 is a form of energy emerging as dimension. Space and Events are complimentary aspects of one system: Space and matter fundamentally act in concert. On the macro-scale, Space is continuously emerging out of Platens 26 from an unknown meta-dimensional source. The emergence of the energy of new pristine Space through the gateway of Platens is the primary cause of expansion of the Universe.

The following excerpts are from: Williams, R., Eudaemon Institute Monograph: 0401. in preparation:

(1) On a macro-scale, pristine Space, [symbol] is in continuous emergence into existing cognate Space, [symbol] Pristine Space, [symbol] emerges through gateways of Platens 26 and Domain Boundaries 34 from an unknown meta-dimensional source. For the purposes of the present discussion, this higher dimensional source is designated to be a 4-dimensional Space,

[symbol]

With existing capability, contemporary instruments present only a vague sense of the energy of Space. This energy is assumed to derive from an unknown matter. By assuming that Space has inherent characteristics in addition to classical concepts of dimension, vacuum, etc., then these energies can be considered fundamental to Space itself.

These characteristics are: First, Space is displaceable. Second, new pristine Space continually emerges into existing cognate Space through Platens and Domain boundaries of Events.

For the purposes of the present discussion, it is assumed that a unit of Space, when added to our existing space from a source outside of our dimension, displaces our existing space. By this activity, ‘pressure’ of space is increased. Pressure may be of short or long duration. Increased pressure emerging through gateways of interlocked Platens is the cause of the expansion of the Universe.

For the purpose of analysis, it is also assumed that Space, [symbol] is composed of fundamental units-Kinetic Centers of Lambda (A) Beginning Space or K-colbs, [symbol] The K-colbs that comprise pristine Space, [symbol] may be highly active on emergence through gateways of Platens and Domain Boundaries. They displace and squeeze cognate Space, [symbol] An infusion process integrates emergent k-colbs of pristine Space, [symbol] with k-colbs of cognate Space, [symbol] The energetic activity/‘pressure’ resulting from [symbol] displacing [symbol] is the primary cause of expansion of the Universe. For simplicity in the present discussion, the number of Kinetic Centers, [symbol] in a certain volume of Space, [symbol] will be considered equivalent to the number of volume units of [symbol] .

(2) Because [symbol] exerts pressure in opposing directions from each individual Platen toward the two Events common to each Platen, the following holds:

The inertial resistance (ir) of ordinary matter (Baryons) to accelerated expansion, plus the +G energy of matter preferring contraction, equals the resistance of the Universe to expansion (re), or
re=ir+G

On emergence, [symbol] overcomes both G (and other forces that can cause contraction) and the inertial resistance, ir, of ordinary matter (baryons) against increasing acceleration: [symbol]
>re, then [symbol]
>G+ir
If the Universe had 0 expansion, then [symbol] =0.

Since the Universe is expanding, [symbol]
+ [symbol] =A, where
A=the cosmological constant.

Since [symbol] has primarily maintenance energy, it can drop from the equation. Then, [symbol]
=A

(3) Platens define the primary spatial/energetic relationships among Events. The emergence of [symbol] occurs through continuously inter-linked Platens/Domain Boundaries enclosing each Event 22. As [symbol] emerges/infuses into [symbol] [symbol] expands with an energy balancing resistance. All the while, [symbol] accommodate various classes of Events that, in turn, interact on numerous hierarchical levels.

Space, [symbol] has a geometric and topological structure determined by (1) interactions among local Platens/Domain Boundaries enclosing an Event; (2) the interaction among Space-Event combinations.

(4) Space as +energy [symbol] in an expanding Universe is not conserved. Space as −energy [symbol] in a contracting Universe is not conserved. The energy of Space is conserved in the context of a completed expansion/contraction process. This process is the singular monumental process of the Universe.
Σ [symbol] = [symbol] + [symbol] + [symbol] +

[symbol]

(5) Viewed as a whole system:
ΣEₜₒₜₐₗ=⁺Eₑₓₚₐₙₛᵢₒₙ+⁻E_{contraction}=0, then
ΣEₜₒₜₐₗ=(⁺Eₘₐₜₜₑᵣ+⁺E_{Space}+⁺t)ₑₓₚₐₙₛᵢₒₙ+(⁻Eₘₐₜₜₑᵣ+⁻E_{space}+⁻t)_{contraction}=0, where
t=time. Energy is conserved.

$$\begin{matrix}∴ \\ \sum {E}_{expansion} = {}_{}^{+}{E}{}_{matter}^{} + {}_{}^{+}{E}{}_{Space}^{} + t , \\ {}_{}^{+}{E}{}_{Space}^{} = \sum ( {E}_{cognate} + {E}_{pristine} ) , where \\ {E}_{cognate} = at {t}_{1} \\ {E}_{pristine} = at {t}_{2} - {t}_{1} , then \\ = \frac{{V}_{{t}_{2}} k T}{Δ {V}_{{t}_{2} - {t}_{1}}} , or \\ {{t}_{2} - {t}_{1}}_{} = {{3}_{{t}_{2}}}_{} k T , where\end{matrix}$$

k=constant of proportionality, T=temperature.

(6) Space [symbol] develops a continuously greater energy component of the total energy in the Universe through time. At present, the inherent energy of [symbol] accounts for 75%+of the energy of the Universe.

At its origin at Platen/Domain Boundary gateways [symbol] is infused into [symbol] that are within or local to other classes of Events. The infusion intensity/energetic pressure, EP, at any location within a Domain diminishes from Platen to Event as:

$$EP ∝ \frac{1}{{r}^{2}} ,$$

where r is the distance from a Platen to Event center, as in FIGS. 9A and 9B. Thus, expansion of space, [symbol] →0 within and around matter at each Event center.

The intensity of energy infusion of [symbol] into [symbol] is diluted as it approaches an Event (matter) because of: (1) the diminishing Domain volume on approach to Event; and (2) the diminishing energy intensity in relation to distance from Platen/Domain Boundary.

At an Event, either: (1) no increased [symbol] enters into the Event itself, or; (2) the increased [symbol] entering into the Event is minuscule and undetectable with existing instruments.

The energy of [symbol] coincides with modifications of Δrₜ_{₂}₋ₜ_{₁} and ΔAₜ_{₂}₋ₜ_{₁}.

$$\sum \approx \frac{Δ {r}_{{t}_{2} - {t}_{1}} Δ {A}_{{t}_{2} - {t}_{1}}}{3} , where$$

r=distance from Platen toward Event,
A=area of Platen.

Accumulated infused energy/vacuum energy, A—expressed as Volume, V, change through time, t, while maintaining its density:

$$\begin{matrix}{\sum }_{r = 0}^{r \to Event} Δ {V}_{{t}_{2} - {t}_{1}} \approx {\sum }_{r = 0}^{r \to Event} Δ {r}_{{t}_{2}} Δ {A}_{{t}_{2}} / 3 - {\sum }_{r = 0}^{r \to Event} Δ {r}_{{t}_{1}} Δ {A}_{{t}_{1}} / 3 , where \\ V = increase at Platen .\end{matrix}$$

(7) The emergence/infusion of [symbol] through Platen/Domain Boundary gateways is the primary pressure causing the expansion of the Universe. The force causing expansion is classically assumed to have a negative gravitational component associated with an undefined matter. However, because expansion is local to every macro-Event/Domain, the energy causing expansion of the Universe can appear to have a negative gravitational component when viewed from an Event, such as the Earth. Actual expansion, however, is the result of increased pressure caused by [symbol] emerging from Platen/Domain Boundaries and displacing [symbol] The force exerted by [symbol] in the vicinity of a single Platen is directed away from the Platen, and toward two related Events simultaneously (see FIGS. 9A and 9B).

Thus, energy emerging into the existing structure of [symbol] Platens, Domains, and Domain Boundaries accounts for the Cosmological Constant, Cosmic Microwave Background, Dark Matter, Dark Energy, and other presently conjectured mysterious forces in nature.

(8) At any given time, the existing vacuum energy pressure, Λ, remains constant. Viewed as a Pressure, P, the possible increase of Λ at t₂ is balanced with decrease of P resulting from expansion. Inertial resistance to accelerated expansion maintains the value of the cosmological constant at Λ, and with Δt, the infused [symbol] with [symbol] (vacuum energy A) results in expansion.

In the perceived and measurable Universe the rate of increase of [symbol] increases as the cube of the increase of the surface, S, of Platen/Domain Boundaries:
Δ [symbol] ≈ΔS³_{Platen} or Δ [symbol] ∝ΔS³_{Platen}
∴
Λ≅ΔS³_{Platen}.

(9) Because: The average number of Platens per Event in the Universe=14; then, the average smallest unit for Domain Boundary=1/14 Event+1/14 Domain+1/14 Domain Boundary (from FIG. 9) (This=one Platen+the sub-Domain Boundaries from Event to Platen.) Then [symbol] enters into opposing Domains (FIG. 9) through Platen/Domain Boundary gateways.

Therefore:
Σ [symbol] ≅=14et[ΣΔ [symbol] + [symbol] _{0→n]}
Where et=number of Events in Universe.

(10) The sum of the energy of Universe expressed as density parameter, Ω:
ΣΩₜₒₜₐₗ≈ΣΩₘₐₜₜₑᵣ+ΣΩ_{Λ}_{ₜ₀}+ΣΩᵢ_{ₜₙ}, where i=infused energy.

(11) Space and matter form an inexorably integrated continuum. The structure of Space takes positive curvature to accommodate matter. However, the curvature of Space is one component of classical gravitational force. Another component is the pressure resulting from the emergence/infusion of [symbol] into

[symbol]

Both curvature of Space and the corresponding gravitational force appear to decrease with distance from Events. At Platens, Spatial curvature/gravitational force→0. Space is approximately Euclidean at Platens, as shown in FIG. 8.

(12) The fundamental equilibrium relationship between and among Events is a Platen relationship, whether the Events are on a macro-scale or a micro-scale. In the present discussion, the concept of structure of Space derives from the organization of interlinked Platens forming Domain Boundaries enclosing related Events. The structural-topological character of Space is a function of the interaction of localized Spaces and the Events themselves. The Platen network at any hierarchical level is typically un-uniform and dynamic (see FIG. 10).

Verification of the existence of Platens and Domains can be determined ‘locally’ from determinations of Platen interactions among local Events from the atomic to the galactic levels.

(13) With respect to the meta-dimensional source of pristine space [symbol] [symbol] =the 3-dimensional Space excess, [symbol] and is the result of presently unknown activities of meta-dimensional Space, [symbol] [symbol] emerges/infuses into cognate Space, [symbol] through Platen/Domain Boundary gateways:
Excess of [symbol] → [symbol] then

$$\begin{matrix} = [ {{4}_{{t}_{2}}}_{} - {{4}_{{t}_{1}}}_{} ] / , where \\ = \sqrt{1 - \frac{\text{(\&)} {u}^{2}}{{c}^{2}}} , where\end{matrix}$$
&=dimensionality constant for 4-dimensions, presently assumed to be 8;
u=1-dimensional component of 4-dimensional Space through time;
c=speed of light. Then:

$$= [ {{4}_{{t}_{2}}}_{} - {{4}_{{t}_{1}}}_{} ] / \sqrt{1 - \frac{\text{(\&)} {u}^{2}}{{c}^{2}}} .$$

As the value of

$$\sqrt{1 - \frac{\text{(\&)} {u}^{2}}{{c}^{2}}} \to \sqrt{i} ,$$

continued expansion of the Universe→0, and contraction begins.

### Fundamental Axioms and Corollaries

Axiom I:

All Events 22 in the Universe are interconnected with Space 66 into a unity.

Axiom II:

The Integraticircumeionicatenatic Principle: The primary interaction between every two related Events occurs at a location, the Platen 26, living between the two Events. A multitude of related Events and Domains 32 exist in concert with Space in a multi-dimensional multi-hierarchical, and omni-directional chain of linked Platens.
Cor I: An Event exists within its Domain. A distinct group of n-Platens encloses each Event of a cluster of Events in relationship. Platens enclosing each Event define the Domain Boundary 34 of the Event.
Cor. II: Platens in relationship unify the omni-directional, multi-dimensional, multi-hierarchical interactions of Events and Domain Boundaries of Space 66. In a dynamic Universe, Platens and Domain Boundaries are in a continual state of change and adjustment.
Cor. III: The Platen 26 interlinking each pair of related Events approaches the form of a Small Circle 52 or Small Polygon 54, bounded by n-Rim 38 segments meeting at n-Nodes 36, common to each Event.
Cor. IV: The Rim of a Platen between two Events appears to have an indeterminate number of finite edges, approaching a circle. The existence of additional related local Events and their corresponding Platens modifies the number of Nodes and Rim segments of a Platen.
Cor. V: When related Events and Domains exist within a certain hierarchical level or dimensionality, the entire level or dimensionality may either embed, or be embedded into, another level or dimensionality of Events and Domains.
Cor. VI: The shortest minimal energy path between two distant locations is a non-geodesic path of inter-linked Platens in Space.
Cor. VII: A localized Space and an Event are a unity of two component parts acting in concert. The structure of Space is inexorably linked to the relationships among Events.
Cor. VIII: The energy of Space emerges through gateways at Platens. An Event, Domain (Space), and Domain Boundary (Platens) comprise a minimal Energetic Configuration.

Geodesic: A classic Geodesic is classically considered to be the shortest distance between two ‘points’ on any surface in any Space. It can be straight or curved, depending upon the nature of the surface or the Space. In the case of a sphere the Geodesic on its surface lies on a Great Circle.

A Geodesic is considered to be the shortest distance between two points on some segment of a Platen or aggregation of Platens. This would, in effect, allow the shortest distance path to be even a lesser distance than is possible on a theoretical geodesic or Great Circle path. This is because the curved Great Circle distance is greater than any great polygon distance between the same two points. It can be demonstrated that a classical Great Circle or Geodesic path between any two points is actually the sum of a series of Platens linked together. The distance traveled along small polygon paths is always less than the distance of the classical Geodesic.

Infusion: Infusion is a process by which pristine Space is integrated into cognate Space. Platens and Domain Boundaries act as gateways in the initial stages. (Refer to Annotated Glossary: Space for an extended discussion.

### GENERAL OVERVIEW OF THE THEORY OF THE INVENTION

Our Universe is composed of Spaces and other Events on a grand scale, both in size and intensity. The interactions among Spaces, and Events can assume many characteristics. Among these characteristics are: (1) the movement of electrons in seemingly stable crystals; (2) the parting of the airs and the waters when we walk or swim; (3) psychological, economic, social, political, aesthetic, etc. relationships; (4) the traversing of mountains and valleys when we move on this planet; (5) the harmonic movement of intergalactic bodies within the structural flow of Space. Events and hierarchies of Events are in continual motion, even though some appear to be motionless. They, in fact, glide beautifully by one another in a continuous cosmic dance.

Until recent times Space as energy has been largely ignored in science. This is principally because of apparent homogeneity, emptiness, and vastness of Space. Instead the primary focus of intellectual and scientific activities have been directed toward those Events that are easily discernable. They lend themselves to demonstrations of concepts of magnitude, direction, and the like.

However, by interpreting the immense activities in the Universe in this isolating way, an important conceptual half of the duality principle that manifests as “Space-Event” is ignored. This conceptual half actually comprises most of the Universe by volume and comprises three-fourths of the invisible energetic activity in the Universe.

Invisible Events and fluctuating energies, such as the Cosmic Microwave Background, have recently peeked our interest, primarily because answers to the questions we now ask will be found only by integrating visible Events dancing throughout Space in unison with the invisible energetic nature inherent in the structure of Space itself.

In recent two-dimensional photographs of Cosmic Background Radiation, CMB (from COBE), the radiation gradients that comprise the fabric of Space are of insufficient detail to clearly show the relational dimensions from which these patterns manifest in the Universe. The present mapping method and system will serve as an aid to resolve this situation. It offers a method and system to show that interlinked Platens are primary determinants of the fabric and structure of Space. See “Cosmic Microwave Background” in http://cmb.physics-.wisc.edu/tuturial/cmb.html, (2000).

In one approach to this method of mapping, interlinked Platens 26 forming Domain Boundaries 34 enclosing each Event 22 are located where Gravitational, and other forces as well, between two interacting Events approach stability. (Refer to annotated Glossary: Space.)

On the astronomical scale, Platens live in what is classically considered to be the darkest areas of Space, energetically speaking. Pristine Space, as an energy source, is continuously emerging into areas occupied by cognate Space. Platens/Domain Boundaries act as gateways for the emergence of pristine Space. The emergence is coupled with the infusion of pristine Space into cognate Space. The emergence and infusion of pristine Space is the primary cause of the expansion of the Universe.

Angular relationships among Events (matter) in the Universe have remained fairly constant throughout the history of the Universe. The distribution of matter in the Universe is also mostly uniform. The energy infused into the Universe in the form of pristine Space is at a relatively uniform rate, while continually increasing in size. From the viewpoint of the Earth, the infusion appears to be a negative gravitational force causing the accelerated expansion among Events.

The concepts that: (1) Space is in a continual emergence; (2) most grand galactic Events in the universe maintain approximately consistent angular and topological relationship to one another throughout time; and (3) the speed of separation of the grand galactic Events is accelerating, presents a reality that will be more clearly understood when it is demonstrated that Space, as energy, is in continual emergence through Domain Boundary gateways from interlinked Platens. Platens and Domain Boundaries define the fundamental structure of Space.

Fundamental Geometric Considerations

The present mapping method and system is presented with the intent of offering a unified method and system: (1) to demonstrate the unified relationships among Events and Space; (2) to clarify the structure of Space; and (3) for depicting the relationships that exist among Events and hierarchies of Events in the physical, psychological and social realms. In order to develop a more complete understanding of the method and system it is important to establish certain fundamental geometric concepts:

Relationships among Events

Scientific studies of sphere-packings have been fundamental to the understanding of: (1) densities of clusterings; (2) how bodies, energies, and the like relate to one another within Spaces of various dimensions; and (3) methods for establishing upper and lower limits for such relationships.

In the geometry of the aggregation of bodies in 3-dimensional space, it is universally understood that when equal size spheres are clustered together, no more than twelve spheres will contact a central sphere. In extensive packings, each sphere in the interior of a cluster contacts twelve spheres. This is the 3-dimensional analog of the 2-dimensional case in which no more than six equal circles can contact any other circle in an array.

However, studies of soap bubble aggregations, bio-logical cell packings, etc., have revealed an interesting difference in their mode of clustering. In the teaching of Kelvin (1887), we understand that because bubbles and cells have the ability to glide and self-adjust to one another, not 12 but 14 of these bodies contact every other body in an extensive cluster. (See FIGS. 6, 7, and 11A)

These two systems of close-packing have related symmetries that are important in understanding certain aspects of the present invention. The symmetries of these two systems of close-packing can change from one to another with the slightest modification. The two symmetries can also be combined into one system that allows packing in either system simultaneously. FIG. 12 and FIG. 13 show these relationships. The symmetry relationships between the rhombic dodecahedron, the characteristic polyhedron associated with sphere packing, and a truncated octahedron, the characteristic polyhedron of bubble packings are shown in FIG. 12. These polyhedra are symmetrically/spatially related through their relationship to the octahedron, which allows the vertices of one to correspond to the faces of the other.

By projecting small circle faces of the octahedron, truncated octahedron, and rhombic dodecahedron simultaneously onto the surface of a circumscribed sphere, the twenty-six small circles are interlinked at thirty locations on a sphere. By connecting these locations an irregular triangulated polyhedron is defined, shown in FIG. 13. This singular polyhedron contains all twenty-six small circle Platens, allowing it to form Platen boundaries with other like polyhedra in either symmetry system. This exemplifies the most flexible way to cluster Events when their interactions are highly symmetrical and uniform. The above characteristics are seen in 70+% of crystal structures of the elements.

Overall, nature exhibits greater randomness than regularity in relationships among Events. Studies with random size bubbles and the like have shown that the average number of contacts per individual in large aggregations ranges from 12 to 14, depending on ability of Events to glide upon one another.

Three further consistent facts have derived from studies of packings of bodies: (1) the angle at which three faces (Platens) meet at a common Rim 38 is 2π/3=120° 56; (2) the angle at which edges meet at a common Node 36 is cos −⅓=109°28′16″ 58; (3) the polygon faces (Platens) show a preponderance of pentagons, approaching 5.143 . . . edges (Rims) per face.

In astronomy studies conducted at the McDonnell-Douglas Advanced Research Laboratories in 1969-1970, by astronomer, Dr. A. G. Wilson and the present inventor, the above-mentioned universal geometric concepts were evaluated in relation to the geometries and topologies existing among inter-galactic structures. We constructed a three-dimensional model of a portion of the Universe and measured the angles and relational distances among the bodies in Space.

Our tentative conclusion: In the distant past, inter-galactic structures could have existed as a dynamic close-packed system of Events with a minimum of Space between Events. For the most part these once close-packed Events, now with immense Space separating them, have maintained mostly consistent angular relationships as the Universe expanded through time (Unpublished work. See Pogosian (1997) for a contemporary verification of these research results).

Small Circles

The concept of Small Circle appears rarely in science and mathematics literature and even less in patents. The Great Circle has garnered attention because great circle arcs on a sphere appear to be the shortest distance between two points on a sphere. Small Circles receive most of their attention in discussions of packing circles on a sphere or covering a sphere with overlapping circles. The teaching of U.S. Pat. No. 4,679,361 to Yacoe (1987) is an example. This teaching is restricted solely to isolated spheres.

However, in observing aggregation patterns of soap bubbles and how they organize themselves, it becomes obvious that a great circle is not to be found. Great circle geometry can, of course, be superimposed on bubble systems much in the same way cartographers imposed a tiling of regular squares and triangles on the surface of Earth. In all of these cases the imposition of Great Circles are known to be problematic and inappropriate.

Systems of clustered bubbles join together with Small Circle Platens 26 that subtly transition into a system of interlinked Small Polygons 54 when more than two bubbles join together. It is within these subtle transitions that the present mapping method and system demonstrates the relationship between Events and Space.

Systematic consideration and analysis of interlinked Small Circle systems has never been undertaken. Though there have been a few patent teachings regarding atomic and molecular models that touch briefly on non-geodesic joining areas.

U.S. Pat. No. 4,622,014 to Mikelsaar (1986) and U.S. Pat. No. 5,947,745 to Tempelman (1999) teache of atomic and molecular spherical models with small circle areas of joining. U.S. Pat. No. 3,276,148 to Snelson (1966) and U.S. Pat. No. 4,099,339 to Snelson (1978) both teach of atom models based upon offset circular ring magnets to represent spinning electrons. However, these patents are restricted solely to the atomic and molecular levels and not related to the multi-level mapping system of the present invention.

Platens and Domain Boundaries

Independent of any specific usage by any discipline, the following discourse uses identical Events for illustra-tive purposes only:

FIG. 3A shows a drawing of two related Events with space between them. In this case, the Platen boundary 26 between two Events extends for an indeterminate distance. In the case where two events have a minimum of contact (FIG. 3B), the Small Circle Platen 26 is diminutive. In the cases where two Events show increased closeness (FIGS. 3c and 3d), the Platens 26 are larger sizes. Finally, in the case where two Events are at maximum closeness (FIG. 3e), the Platen 26 becomes a Great Circle 64. The relationship between two Events degenerates to a single Event.

In the case where three Events 26 are in a relationship, as shown in FIG. 4: Three Platens define the relationship. Rims 38 meet, change direction, and bond at the 120° angle 56 mentioned above. In all cases of three or more related events, Platens may also be visualized retaining their Small Circle characteristics and link together by passing through one another as shown in FIG. 7.

In the case where four Events are in relationship, FIG. 4: Six Platens define the relationship. Again, in this case Rims meet, change direction, and bond at the characteristic angles of 120° 56 and 109°28′16″ 58. Platens may also be visualized passing through one another as shown in FIG. 7.

In cases of multiple Events in relationship, Events may be added indefinitely. Platens continue to form. FIG. 6 shows the relationships among fifty Platens that define relationships for fifteen clustered Events.

These examples underscore the unified dual nature of a continuous Event-Space relationship based upon Platen geometry and topology. It is noted that Events rarely exhibit identical sizes-energies-intensities. Platens and Domain Boundaries in the real world are therefore non-regular in size and shape, as shown in FIG. 1 and FIG. 10. Continuous Platen linkages exist throughout.

Relationships Among Differentiated Systems

The symmetry relationships, topological transfor-mations, and hierarchical relationships between systems of close-packed spheres and close-packed bubbles present an illustrative limiting case, demonstrating one of many ways that hierarchical relationships among Events can to be mapped in the present invention.

A standard idealized shape for regularly packed, equal volume compressed spheres is a polyhedron called rhombic dodecahedron, shown in FIG. 11B. An idealized polyhedron for aggregated equal volume soap bubbles is a truncated octahedron, shown in FIG. 11A. Their relationship is shown in FIG. 12, in which the faces of one polyhedron correspond to the vertices of the other polyhedron.

Each of these two polyhedra can also be generated by interlocked Platens corresponding to their respective faces. These Platens 26 can be projected onto the surface of a single sphere. The connection of the spherical surface junctions of these small Circle Platens 26 defines the polyhedron in FIG. 13. This special geometry of this polyhedron contains the inherent symmetries and Platens of both of the original polyhedra. Its Platens will allow it to be packed in both the coordinate system of hard sphere packings and bubble packings.

Theoretical Determinants of Platen Locations and Characteristics

Within the method of mapping relationships among Events in any discipline, many theoretical relational modalities are possible. The inventor presents examples of some useful equations for the determination of Platen characteristics and locations between Events. In Table 120 equations assume the form: A=B[(C)+/−(D)] with assigned concepts for A, B, C, and D. The concepts come from: Newton's 2^{nd} Law; the determination of zero gravity Platen locations; the balanced surface tension Platen locations; the potentials resulting from attractive-repulsive forces among atoms and/or molecules; and the rates of acceleration in the expansion of the Universe.

TABLE I:20
Selected Relational Modalities of Platens and Domain Boundaries
In the General Form of the Equation:
A = B[(C) ± (D)]

| | Component | A | B | C | +/− | D |
|---|---|---|---|---|---|---|
| 1 | Newton 2^{nd} Law Equation | F = force between Events | T = tension between Events | 1 | + | $\frac{M}{{M}_{1}} , where m = masses of Events$ |
| 2 | Lagrange Equation For L1 | L1 = center of Platen along R | R = distance between Events | 1 | − | $\frac{{α}^{1 / 3}}{3} , where α = \frac{m}{{mm}_{1}}$ |
| 3 | Laplace-Young Equation | p = excess pressure | σ = surface tension | $\frac{1}{R} ,$ where R =radius of curvature | + | $\frac{1}{R} ,$ where R =radius of curvature |
| 4 | Lennard-Jones Potential Equation | V_{VJ} = Potential: attractive- repulsive forces | 4ε, where ε =L-J parameters- interacting particles | $\frac{{Ω}^{12}}{R} ,$ where R = L-J parameters | − | $\frac{{σ}^{8}}{{R}_{1}} ,$ Where R =separation of Events |
| 5 | Sandage Deceleration Parameter | q₀ = repulsive energy | $\frac{Ω}{2} ,$ where Ω =critical density of Events | 1 | + | $\frac{3 p}{p} ,$ Where p =pressure of Events |
| 6 | — | — | — | — | — | — |

Notes:
1. Feynman, R., “Newton's Laws of Gravitation,p” The Feynman Lectures on Physics. Menlo Park: Addison-Wesley Publishing Company, 1963. .pp. 10-1 to 10-9.
2. Cornish, N., and Goodman. J. “The Lagrange Points.” pp. 1-8. (2) is used for the determination of Lagrange Point (L1) [the center of a (theoretically) indefinitely extended Platen, whose boundary of Nodes and Rims is determined by the Platen's interaction with other Platens.]
3. Isenberg, C. “The Laplace-Young Equation,” The Science of Soap Films and Soap Bubbles, pp. 107-113. (3) is used when surface tension is a primary factor.
4. “The Lennard-Jones Potential”., http://www.fisica.uniud.i.t (4) is used for determining the interaction potential among atoms.
5. Turner, M., “Cosmology Solved? Maybe.” Published in “Black Holes and High Energy Astrophysics”, Proceedings of the Yameda Conference XLIX on Black Holes and High Energy Astrophysics held on 6-10 April, 1998. (5) is used when certain pressures in a system cause expansion or contraction.

These equations can be extrapolated to apply within other disciplines. For example, in the area of consciousness technology, the location of a Platen in equilibrium would be considered to be the relational geometry by which Space-Event allowed the clearest communication to be transmitted. If a Platen is not in balance, focus is lost and the information transmitted is no longer part of consciousness, but simply noise.

### GENERAL DESCRIPTION AND SUMMARY OF THE INVENTION

The inventor believes that his invention is distinctly different from all prior art. In order to address these and other shortcomings of the prior art, it is a feature and advantage of the present invention to provide a unified method and system for creating maps of the spatial relationships and the energy relationships among Events in the Universe. These relationships include: (1) very small fundamental particles, (2) large bodies or clusters of bodies on an astronomical scale, (3) relationships among hierarchical levels, (4) parallel Universes, (5) the fundamental unity of Event-Space.

### OBJECTS AND ADVANTAGES

From the above description, the reader can appreciate the following objects and advantages of the present invention:
(a) To provide a unified method and system for understanding the structure of Space.
(b) To provide a unified method and system for the comprehensive mapping of the spatial domain relationships and energy domain
(c) relationships among very small Events in the Universe to the very large Events in the Universe.
(d) To provide a unified method and system to demonstrate the interconnectedness of all Events and Space.
(e) To provide a unified method and system by which near zero energy interlinked boundary Platens among Events in the Universe can be clearly delineated.
(f) To provide a unified method and system to serve as a basis for a clear understanding of the nature of friction, sound transmission, and the like, the application of which will lead to more efficient ways of movement of objects.
(g) To provide a unified method and system to serve as a basis for a theoretical understanding of a means for near zero energy Space travel.
(h) To provide a unified method and system for a clear understanding of the singular nature of attractive and repulsive forces in the Universe.
(i) To provide a unified method and system for understanding the mechanical process by which pristine Space continually emerges into the known Universe through gateways at Platen/Domain Boundaries.
(j) To provide a unified method and system for a clear understanding of the interconnectedness among various forces and entities that manifest as hierarchies of systems.
(k) To provide a unified method and system for clear visualization of the hierarchical nature of spatial, energetic, and dimensional levels of Event-Space existence.
(l) To provide a unified method and system to allow for the determination of zero force Platen boundaries for Events manifesting as solids, liquids, gases and spaces.
(m) To provide a unified method and system for the theory of disease mechanics, i.e. the mechanism by which biological tissue systems allow foreign detrimental compounds to participate in normal activities of a system.
(n) To provide a unified method and system to develop the understanding of the mechanism by which thoughts are transferred from one living being to another.
(o) To provide a unified method and system for understanding the theoretical commonalities among the ways Events interrelate, from the atomic and sub-atomic levels, to the immense bodies in space, to psychological and other modalities.
(p) To provide a unified method and system that demonstrates the physical mechanism for Entanglement Theory.
(q) To provide a unified method and system for demonstrating the mechanics of neural networks.
(r) To provide a unified method and system for determining the likely locations of ‘black holes’ in the Universe.
(s) To provide a unified method and system for demonstrating the patterns and sources of Space weather.
(t) To provide a unified method and system to describe the patterns for the energy gradients of Cosmic Microwave Background.
(u) To provide a unified method and system for demonstrating that Platen/Domain Boundaries are the gateways of the pressure causing the Universe to expand.
(v) To provide a unified method and system to demonstrate ways to overlap and overlay maps and models from various hierarchical levels both within a certain discipline and among differing disciplines.

Further objects and advantages will present themselves from a consideration of the following description and drawings.

### BRIEF DESCRIPTION OF DRAWING FIGURES

The present invention will be understood more completely when the detailed description and the accompanying drawings are considered together. The drawings are provided for illustrative purposes only, and are not meant to be a limiting factor of the present invention; wherein:

FIG. 1 shows the fundamental geometrical and topological characteristics among Events, Domains, Domain Boundaries, and Platens of the mapping system.

FIG. 2 shows a flow chart depicting the generalized method for the development of the multi-level, hierarchical, n-dimensional mapping of related Events.

FIGS. 3A, 3B, 3C, 3D, and 3E shows basic characteristics of Platens between two Events.

FIGS. 4A and 4B shows geometrical/topological aspects of the relationships of three Platens to one another in the context of three related Events.

FIGS. 5A and 5B shows geometrical/topological aspects of the relationships among six Platens in the context of four related Events.

FIG. 6 shows geometrical/topological aspects of the relationships among a cluster of Events, Platens, Domains and Domain Boundaries.

FIG. 7 shows three of numerous ways to depict interlinked Platens forming Domain Boundaries of a single Event.

FIG. 8 shows selected aspects of the way Domains, Domain Boundaries, Rims, and Platens can exist in the context of three related Events.

FIGS. 9A and 9B shows topological and spatial aspects of the relationships between individual Platens and Events.

FIG. 10 shows a characteristic example of a Domain Boundary of Platens for a single Event in an aggregation of Events of random size and/or intensity.

FIGS. 11A and 11B shows an example of a process of developing geometric/topological relationships between hierarchical levels of Events.

FIG. 12 shows a geometric relationship between the Rhombic Dodecahedron and the Truncated Octahedron.

FIG. 13 shows examples of the 26 Platens within a certain characteristic polyhedron.

### REFERENCE NUMERALS IN DRAWINGS

20 Table of Equations
22 Event
24 Cluster of Events
26 Platen
28 Cluster of Platens
30 Directionally Oriented Platen Group
32 Domain
34 Domain Boundary
36 Node
38 Rim, Rim Segment
40 Two Related Events
42 Three Related Events
44 Three Platens and Common Rim
46 Four Related Events
48 Six Platens, Common Rims, and Node
50 Central Event and Related Platens
52 Small Circle
54 Small Polygon
56 Dihedral Angle
58 Tetrahedral Angle
60 Event Cluster with Central Domain Boundary
62 Cluster of Domain Boundaries
64 Great Circle
66 Space

### DETAILED DESCRIPTION—PREFERRED EMBODIMENTS OF THE PRESENT INVENTION

In accordance with the theoretical principles of the present invention: A unified method and system utilizing a non-geodesic geometry of integrated Small Polygons 54 and Small Circles 52 to generate maps of dynamic spatial-energy relationships among micro-Events and macro-Events in the Universe. This method and system integrates hierarchical levels of existence and multi-dimensional relationships among Events. This method and system assumes universal continuous integrated relationships among all Events with their local spatial structures. The maps can demonstrate the explanation for the expansion of the Universe by showing the energetic qualities inherent in the nature of Space.

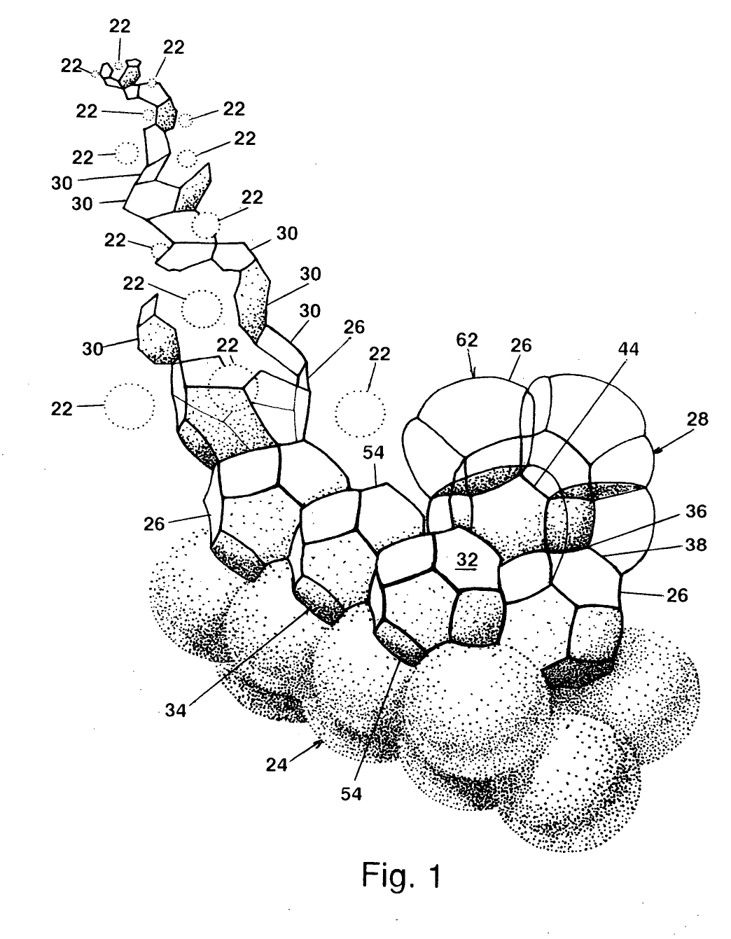

FIG. 1 shows a variety of geometric-topological characteristics of the invention: Specifically, FIG. 1 shows:
(1) A regularly aggregated Cluster of Events 24. FIG. 1 shows Events 22 as equal and regularly clustered, as well as of unequal size and randomly clustered.
(2) An example of a Domain 32 is shown interfaced with similar Domains. Examples of Domain Boundaries 34 are shown to be the enclosure of a Domain. A Domain Boundary 34 is composed Platens 26. Platens can resemble Small Polygons 54. In FIG. 1 some of the Small Polygons appear as hexagons and squares, though polygons of differing numbers of Rim segments 38 and Nodes 36 are also possible.
(3) As mentioned above, Events 22 can be equal or random in size and arrangement. Events can also be determined to have a specified direction to them. In cases of this type, the Platens 26 can be calculated to be components of a directionally oriented group 30. In these cases, Platens are inter-linked and folded in order to map the relationships among Events 22, Domains 32 and Domain Boundaries 34, having a specific directional orientation. FIG. 1 shows a cluster of Domain Boundaries 62 as well as examples of Nodes 36 and Rims 38.
(4) FIG. 1 shows three platens and a common Rim 44. Examples of Nodes 36 are shown.
(5) In addition, FIG. 1 shows a way in which Platens 26 define Domains 32 and Domain Boundaries 34 of inter-related clusters of Events 24, 62.

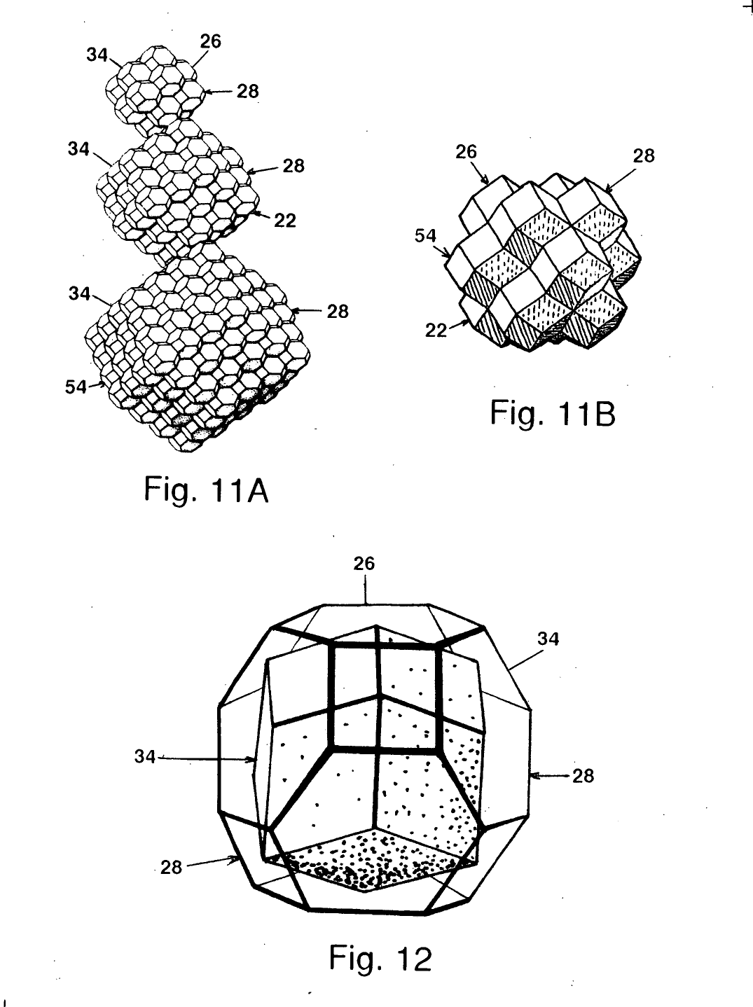

In accordance with the theoretical principles of the present invention, the Flow Chart of FIG. 2 shows:
(1) The selection and initiation of the mathematics and processes for determination of mapping character-istics.
(2) Table of Equations 20 or other conceptual tools may be used to begin the process.
(3) Following (1) above, any two initiatory related Events 40 are selected and, a unitary Platen 26 between them is determined.
(4) This is followed by the iterative sequence of adding one Event 22 after another to established Clusters of Events 24, 28. This process establishes Domains 32, Domain Boundaries 34, and Platens 26 of related Events 22. The evolving map or model may be omni-directional 60, linear 30, and/or hierarchical in its method of development and its system for inclusion of added Events 22.
(5) FIG. 2 depicts the continuing series of evaluation procedural steps at which the selection of each added Event 42, 44, 46, 48, 50 determines whether the Event: (a) exists on the same hierarchical level; (b) exists embedded within a previously mapped Event, or; (c) exists by embedding all previously mapped Events within it. (Refer to FIGS. 11A and 11B for a geometric-topological example of embedding hierarchical levels.)

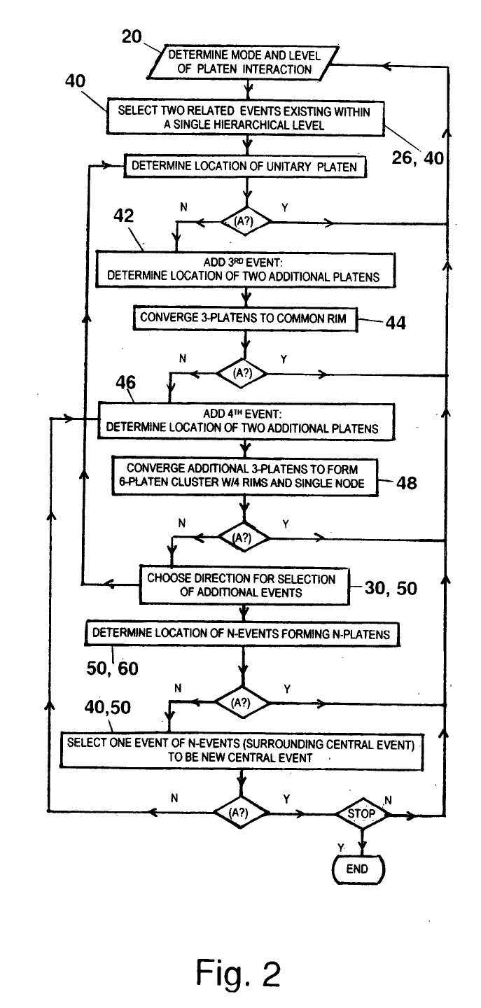

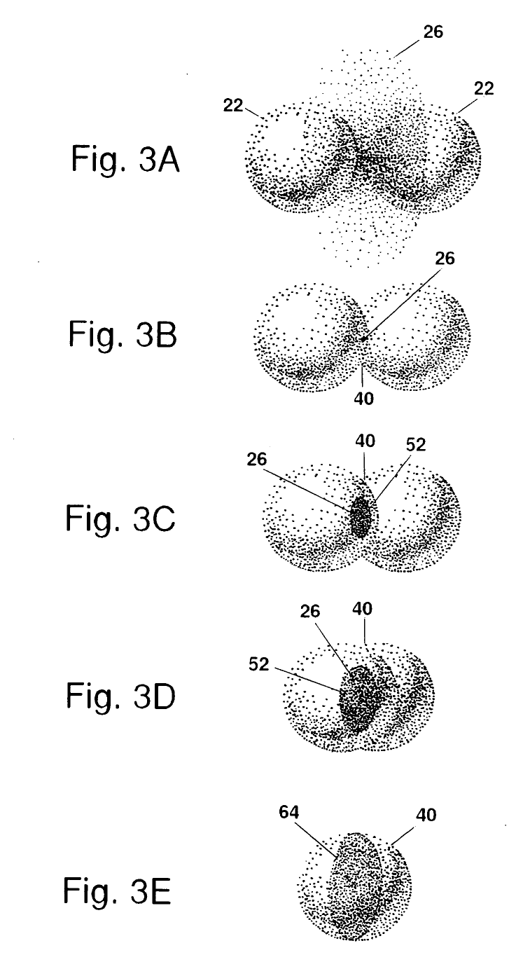

In accordance with the theoretical principles of the present invention, FIG. 3A, B, C, D, E shows examples of geometric/topological conditions for the formation of a unitary Platen 26 between two Events 22. (It should be noted that iterative mapping and visualization of Events, Spaces, Platens, Domain Boundaries, etc., may exist on a single plane or in an omni-directional cluster of components, depending upon the depth of analysis required.):
(1) Events 22 can be considered to be in direct contact with one another or separated from one another. The Platen 26 shown in FIG. 3A exists between the two separated Events 22. The location of the Platen is established by mathematical and other considerations of the size, energy intensity, interaction potentials, and the like, of the two Events. In disciplines of the physical sciences, these considerations may take the form of equations in Table I 20. Other equations and/or considerations may be required in other contexts of other disciplines. The Platen 26 shown in FIG. 1A can be extended indefinitely. It has, therefore, an indeterminate diameter that can be established and limited by interaction with other Platens.
(2) The Platen 26 in FIG. 3B results from the initial contact of two Events 40. This Platen can be considered to approach the size of the Euclidean concept of point.
(3) The Platen 26 in FIG. 3C has an increased size from the Platen in FIG. 3B. It approximates a Small Circle 52 common to two Events.
(4) The Platen 26 in FIG. 3D has an increased size from the Platen in FIG. 3C. The size of a Platen between two Events is a function of energy relationships between the two related Events.
(5) The Platen 26 in FIG. 3E has increased its size to become the size of a Great Circle 64 common to both Events 40. In this case the two Events have significantly overlapped/degenerated to appear as one Event. From FIG. 3E it is seen that, though Great Circles 64 can be overlaid on an Event, the primary relationship between two Events is determined by an interface of Small Circle 52 and Small Polygon 54 geometry and topology.

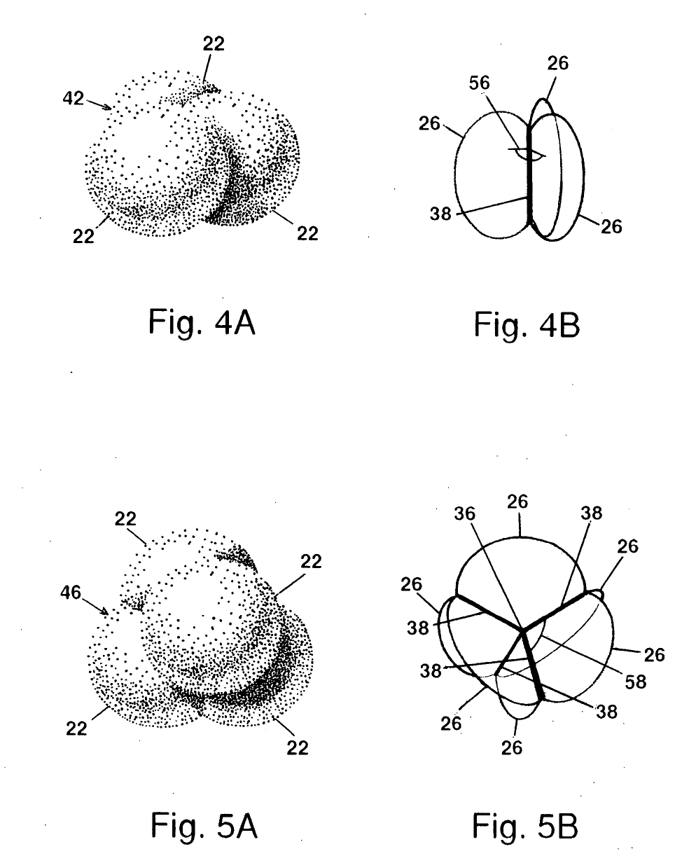

In accordance with one embodiment of the present invention: FIG. 4 shows an example of Platen 26 interaction created by the inter-relationships of three Events 42. FIG. 4A shows three related Events 22 having a contact similar to the kind shown in FIGS. 3C and 3D.

FIG. 4B shows an example of the three Platens 26 of three Events 22 in FIG. 4A. The Platens are interlinked. They share a common area at the Rim segment 38. In dynamic systems, the typical dihedral angle 56 of Platens 26 and Domain Boundaries 34 at a common Rim 38 approaches 2π/3=120°. Other dihedral angles are also possible.

The addition of a fourth Event is shown in FIG. 5A, in which four Events 46 are interrelated. A four-Event system typically results in the interaction of six Platens 26 among the related four Events, as shown in FIG. 5B. The Six Platens share a common Node 36 at which the four Rim segments 38 meet. A typical tetrahedral angle 58 at a Node 36 approaches cos −⅓=109°28′16″. As with Dihedral angles, Node-Rim angles may also vary from the typical case.

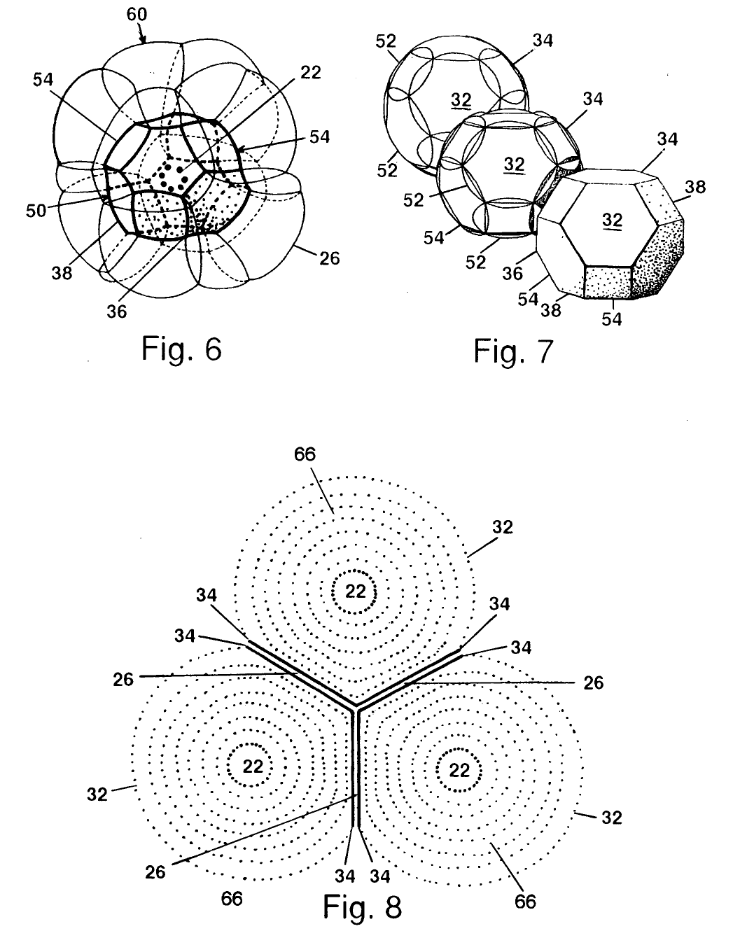

FIG. 6 shows the result of the iterative addition process of clustering Events. The process results in a complete enclosure of one Event 22 by n-Events 60. FIG. 6 shows one of many possible examples of interacting Domain Boundaries 34 of fifteen Events 60, in which fourteen Events surround a single Event. In the example, fifty Platens 26 are inter-linked.

In accordance with one embodiment of the present invention: FIG. 7 shows three of the alternative ways of depicting Platens 26 forming a Domain Boundary 34 enclosing a Domain 32. In this example, three truncated octahedra are shown, each having eight hexagon and six square faces. The Platens 26 are depicted: (1) as the hexagon and square faces themselves; (2) as composed of interlocking Small Circles 52; and (3) as made of interlocking Small Circles 52 on the surface of a Domain Boundary 34. For purposes of illustration of the method of map-making, each of these three alternative approaches can be used to present differing visual representations of Platens 26 and Domain Boundaries 34 of Events 22.

In accordance with a preferred embodiment of the present invention: FIG. 8 shows an example of details of a mode of connection for inter-related Events 22. FIG. 8 shows a more detailed interpretation of the Domain Boundaries 34, Platens 26, Nodes 36, and Rims 38 of FIGS. 1, FIGS. 4A and 4B, FIGS. 5A and 5B, and FIG. 6.

FIG. 8 also shows that Space 66 within a Domain 32 tends to curve around each Event 22 and tends to flatten at each Domain Boundary 34. It is at the Platen 26 areas that the various forces between Events→0. (See: Annotated Glossary: Space)

FIG. 8 shows that, while each individual Event 22 maintains an independent existence, it also exists within a community of relationships. It is fundamental concept of this invention that a continuous multi-directional, multi-level linkage of Platens 26 exists among all Events 22.

From the example shown in FIG. 8, it is clear that the actual depth of analysis of Domain Boundaries 34 and Platens 26 can be as simple as depicting them having Euclidean points, lines and planes. The analysis can also be more complex. For example they may be depicted as intricate systems with discrete interacting components, as shown in FIG. 8. Also, the Spatial 66 content of Domains can be depicted with interwoven energies that may interlink with the energetic content of other Domains.

With respect to the preferred embodiment of the invention: The actual sizes, conditions, and/or energies of related events are rarely uniform. Random locations, sizes, and energies of related Events 22 are more the rule than the exception. Given this randomness, however, there are five General Characteristics that tend to remain constant:
(1) The dihedral angles 56 formed by Platens 26 about each Rim segment 38 approach 2π/3=120°. This natural requirement can cause the Platens to be flat, singly curved, doubly curved, or randomly curved when local conditions are taken into account.
(2) The tetrahedral angles 58 approach cos −⅓109°28′16″. This requirement can also cause Rims 38 to bend, depending on other local conditions of Events 22.
(3) In random aggregations of Events of differing sizes, intensities, etc., the average number of Platens per Event will be >12 and <14 Platens. In dynamic aggregations of Events 22, such as exhibited in soap bubble clusters, the average number of Platens per Event is close to 14. In more static aggregations, such as exhibited in crystals, the average number of Platens 26 per Event 22 is close to 12.
(4) In random aggregations of Events of differing sizes, intensities, etc., the average number of Rim segments 38 per Platen 26 approaches 5.2.
(5) For dimensions greater than three, the above rules apply, with added rules specific to the higher dimension.

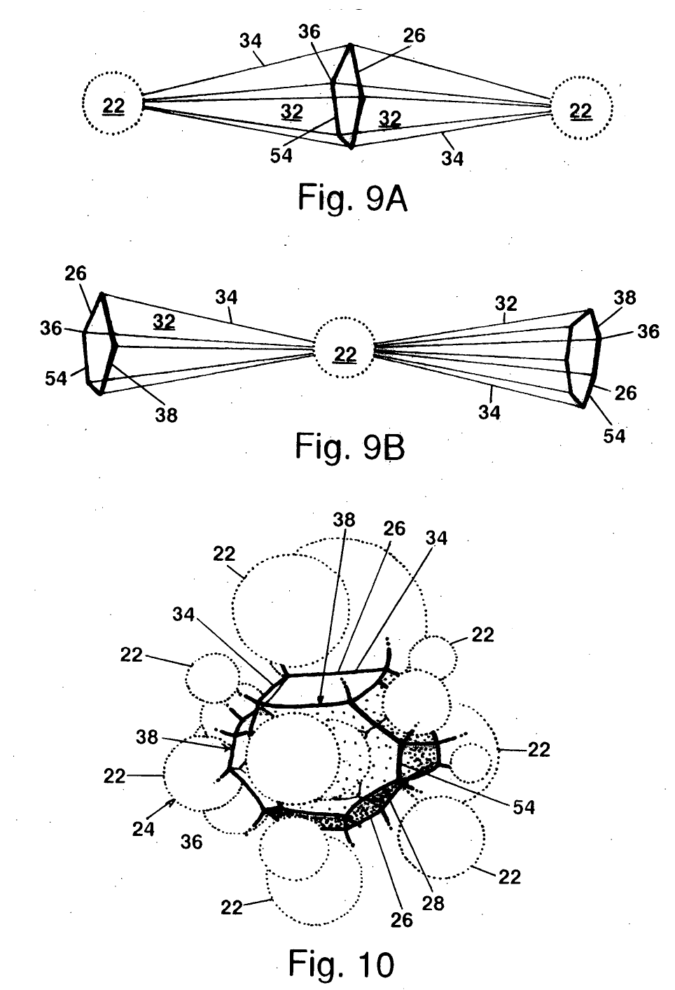

In accordance with the principles of the present invention: FIG. 9 shows two ways of viewing minimal energetic subdivisions of Domains, Domain Boundaries, individual Platens, and individual Events.

FIG. 9A shows geometric/topological relationships between a single Platen 26 and each of two Events 22. The Domains 32, taken as a whole, exist in the form of a bi-pyramid.

FIG. 9B shows geometric/topological relationships between two Platens 26 and a single Event 22. Each Domain 32 of an Event and a single Platen exists in the form of a pyramid.

FIG. 9A indicates boundary conditions and direction of energy relationships. By combining concepts shown in FIG. 8, FIG. 9A, and FIG. 9B, visualization of the general manner in which Space 66 bends and flattens from Event 22 to Platen 26 is possible. This visual information can be presented as an important component of the mapping system of the present invention.

FIG. 9 also shows a way to visualize how Space is compressed within Domain Boundaries. More detailed mapping of energetic configurations within the Domain Boundaries is possible by careful analysis. (Refer to annotated glossary: Space for an analytical overview.)

In accordance with the principles of the present invention: FIG. 10 shows an example of a random aggregation of Events 22. Here sixteen Events 22 are shown. The size and shape of the Domain Boundary 34 of one central Event 22 and its corresponding 15 Platens are shown to define an irregular form of a non-regular polyhedron more likely to be found in dynamic systems. Again, the General Character-istics presented above are typical.

In accordance with the principles of the present invention: From the flow chart shown in FIG. 2, within the loop following a “Yes” answer to the question regarding hierarchical levels of added Events into the map, the following generally holds true:
(1) If the newly considered Event enters on a level above the level being mapped, the entire existing map is embedded within the new Event entering at the higher level.
(2) If the newly considered Event enters on a level that is below the level being mapped, the entire entering Event is embedded within an Event on the level being mapped.

With respect to the preferred embodiment: As a simple illustration of one way that hierarchical levels can relate to one another, the following geometric/topological example is presented: Begin with the form of a truncated octahedron, as shown in FIG. 7, to represent a Domain Boundary 34 of an Event 22.

Concentric shell aggregations Nₛ of truncated octahedra, as shown in FIG. 11A, can encapsulate a central truncated octahedron (to) in concentric layers containing 14, 50, 110, . . . . truncated octahedra according to the Equation:
Nsₜₒ=12s²+2,
where s is shell number 1, 2, 3, . . .

The total number of truncated octahedra in concentric shell clusterings is given in the Equation:
ΣNsₜₒ=4s³+6s²+4s+1,
where s is the outer shell number 1, 2, 3, . . .

It is observed from FIG. 11A that the aggregated truncated octahedra, forming each concentric shell define the general shape of a rhombic dodecahedron (rd). All of the aggregations of truncated octahedra Domain Boundaries exist on one hierarchical level. Individual clusters of these Domain Boundaries, now defining rhombic dodecahedra, can be aggregated as discrete Events of rhombic dodecahedra, at another hierarchical level, as shown in FIG. 11B.

Rhombic dodecahedra can pack in concentric layers of 12, 42, 92, . . . according to the Equation:
Ns_{rd}=10s²+2,
where s is the shell number 1, 2, 3, . . . .

The total number of rhombic dodecahedra in concentric shell clusterings is given in the Equation:
ΣNs_{rd}=(10s³+15s²+11s+3)/3,
where s is the shell number 1, 2, 3, . . . .

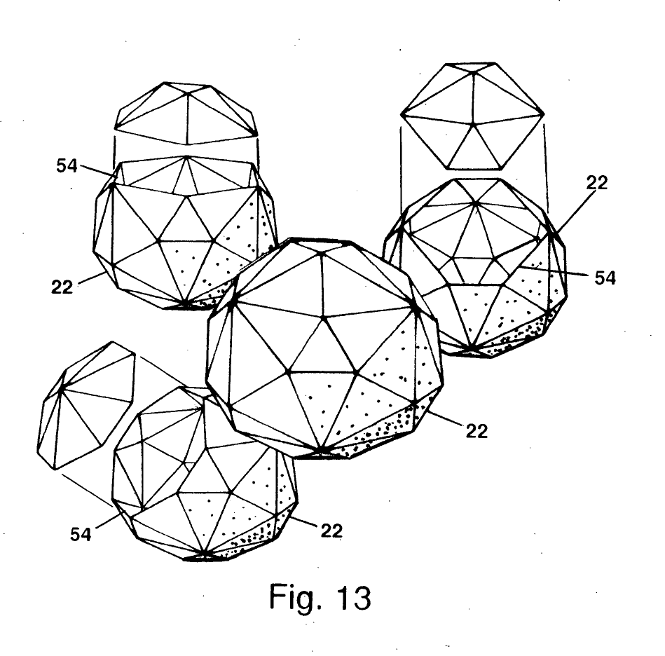

With respect to the preferred embodiment of the present invention: The examples shown in FIG. 12 and FIG. 13 can assist in visualizing one way in which differing symmetries can be used to generate Platens 26, Domains 32, and Domain Boundaries 34.

An important symmetry/spatial relationship exists between the truncated octahedron and the rhombic dodecahedron. FIG. 12 shows that the vertices of one polyhedron to correspond to the faces of the other polyhedron.

By projecting Small Circle 52 faces of the truncated octahedron and the rhombic dodecahedron onto the surface of a circumscribed sphere, the twenty-six Small Circles are interlinked at thirty locations on the sphere. By connecting these locations an irregular triangulated polyhedron is defined, as shown in FIG. 13. This singular polyhedron contains within its interior, all of the twenty-six small polygon 54 Domain Boundaries 34 that are typical of close packed crystal structures and bubble systems.

### Conclusion, Ramifications, and Scope

From the above description, the reader can understand a number of advantages for a mapping system of this kind as evident:
(1) The fundamental interconnectedness among all Events in the Universe is clearly demonstrated.
(2) A comprehensive mapping of the energetic structure of Space in relation to Events is achieved.
(3) Spatial-energy relationships of many species of Events are clearly demonstrated.
(4) Hierarchical relationships of various levels of existence can be mapped and visualized.
(5) Bases for a clearer understanding of the nature of friction, sound transmission, and the like, are demonstrated.
(6) The basis for a theoretical understanding of a means for near zero energy space travel is established.
(7) The singular nature of attractive and repulsive forces in the Universe that manifest as a result of the interaction of Space and Mass is delineated.
(8) A presentation is made demonstrating the concept: The cause of the expansion of the Universe is the emergence of pristine Space through gateways of Platens.
(9) The basis for a comprehensive theory of disease mechanics is established.
(10) The basis for a comprehensive theory for understanding the mechanism by which thoughts are transferred from one living being to another can be initiated.
(11) The basis can be visualized for understanding theoretical commonalities among the ways Events inter-relate, from the atomic and sub-atomic levels, to the immense bodies in space, to relationships within soft science disciplines, and the like.
(12) The physical mechanism for Entanglement Theory is visualized and presented.
(13) A comprehensive system for the mechanics of neural networks is presented.

It can be seen, therefore, that the foregoing represents a highly extensible and advantageous approach to hierarchical and multi-dimensional map-making. While the invention has been described with reference to certain embodiments thereof, it is understood and has been reiterated throughout this disclosure that certain changes, modifications, and specific approaches may be made which are within the spirit and scope of the invention as well as within the skill of the art. The description presented should be construed as a methodological guide for the process of creating the system of unified maps of fundamental relationships among Events in the Universe, both on a micro- and on a macro-scale. The disclosure of the present invention is intended, therefore, to include various modifications and equivalent arrangements included within the spirit and scope of the appended claims.

1. A method of generating multi-dimensional and multi-hierarchical maps to show spatial and energy relationships among a plurality of related events 22 in the universe, wherein:
(a) each of said events and its surrounding spatial domain 32 is shown enclosed by a domain boundary 34,
(b) each said domain boundary is shown to approximate the shape of a modifiable sphere,
(c) each pair of inter-related said events is shown modified by a common platen 26 between said events,
(d) each said platen is shown characteristically having a diameter less than the approximate diameter of the smaller of the two said events,
(e) a plurality of said platens of a plurality of said events are shown linked together to depict said multi-dimensional and multi-hierarchical map depicting form, geometry, and topology of said events, said domains, said domain boundaries, and said spatial and energy relationships,
(f) interlinked said platens are shown as continuous interconnected pathways among said events and said domain boundaries depicted in said map,
whereby the relationships among events in space 66 and space surrounding events are demonstrated, and whereby the structural, geometric, and topological relationships among events, domains, domain boundaries, platens, and space are presented.

2. A method for generating said multi-dimensional and multi-hierarchical maps as recited in claim 1, whereby said maps are generated by an iterative process, such that location and characteristics of each said platen between said pairs of said events is established by use of a variety of mathematical rules and conceptual conventions.

3. A method for generating said multi-dimensional and multi-hierarchical maps as recited in claim 2, wherein:
(a) said domain boundaries of every two related said events are modified and linked by said platen,
(b) said platens characteristically having said diameter less than the said approximate diameter of the smaller of two said events.

4. A method for generating said multi-dimensional and multi-hierarchical maps as recited in claim 2, wherein:
(a) said domain boundaries of three or more related said events are modified by an interlinked plurality of said platens,
(b) said platens characteristically modifying their shape by the process of inclusion into said map of additional said events and their accompanying said domain and said domain boundaries.

5. A method for generating said multi-dimensional and multi-hierarchical maps as recited in claim 2, wherein:
(a) said iterative process requires a decision to place each added said event on one of said multi-hierarchical and said multi-dimensional levels,
(b) said iterative process requires that, as each said event and its accompanying said Domain is added to the said map, a decision is made regarding whether or not there exists a grouping of other said events within or without the added said event,
(c) said iterative process requires that said decision is within the context of the added said event.

6. A method of generating multi-dimensional and multi-hierarchical maps to show spatial and energy relationships among a plurality of related said events in the universe, comprising:
(a) providing each of said events with a surrounding spatial domain,
(b) providing each said domain with an enclosing domain boundary,
(c) providing each said domain boundary with the approximate shape of a modifiable sphere,
(e) providing a means which will:
(1) show each pair of related said events having a common platen boundary between said events,
(2) show each said platen having a diameter smaller than the approximate diameter of the smaller of two related said events,
(3) show a plurality of said platens of a plurality of said events linked together to define said multi-dimensional and said multi-hierarchical map,
(4) show form, geometry, and topology of said platens, said domains, said domain boundaries, and said events,
(5) show interlinked said platens having continuous interconnected pathways among said events and said domain boundaries contained within said map,
whereby the relationships among events in space and space surrounding events are demonstrated, and whereby the structural, geometric and topological relationships among events, domains, domain boundaries, platens, and space are presented.

7. A map system showing multi-dimensional and multi-hierarchical spatial and energy relationships among events in the universe, from the very small events to the very large events, wherein:
a) said structure, said spatial geometry, said domain and said domain boundaries enclosing each said event and assemblies of said events are shown,
b) each said domain boundary is assumed to approximate the shape of a modifiable said sphere,
c) each pair of inter-related said events is modified by a said common interfacial platen between them,
d) said platens of a multitude of said events are linked together to define said multi-dimensional and multi-hierarchical map showing the said form and geometry of said domains and said domain boundaries,
e) said platens interlinked to show said paths of connectedness among all of said events, all of said domains, and all of said domain boundaries contained within the said map system.
